(19) United States
(12) Patent Application Publication
(10) Pub. No.: US 2020/0045969 A1
(43) Pub. Date: Feb. 13, 2020

(54) Fungicidal Composition and Fungicide for Controlling Asparagus Stem Blight

(71) Applicant: Institute of Plant Protection, Jiangxi Academy of Agricultural Sciences, Nanchang (CN)

(72) Inventors: Yingqing Yang, Nanchang (CN); Bo Lan, Nanchang (CN); Meiqiong Xie, Nanchang (CN); Qiang Sun, Nanchang (CN); Hongfan Chen, Nanchang (CN); Longjiang Wang, Nanchang (CN); Jian Chen, Nanchang (CN); Xiangmin Li, Nanchang (CN)

(73) Assignee: Institute of Plant Protection, Jiangxi Academy of Agricultural Sciences, Nanchang (CN)

(21) Appl. No.: 16/243,365

(22) Filed: Jan. 9, 2019

(30) Foreign Application Priority Data
Aug. 9, 2018 (CN) 201810902508.9

(51) Int. Cl. A01N 43/707; A01N 37/52; A01N 25/04; A01N 25/14

(52) U.S. Cl. CPC A01N 43/707; A01N 25/14; A01N 25/04; A01N 37/52

(57) ABSTRACT

The present invention provides a fungicidal composition and a fungicide for controlling asparagus stem blight, and belongs to the technical field of controlling asparagus stem blight. The composition includes difenoconazole and propamidine; and the weight ratio of the difenoconazole to the propamidine is 20:1-1:20. The fungicide of the present invention includes difenoconazole, propamidine and an auxiliary material; and the difenoconazole and propamidine account for 3%-90% by mass of the total amount of the fungicide. The present invention uses difenoconazole and propamidine as active ingredients, where a combined use of them has a synergistic effect on the pathogenic fungi of asparagus stem blight, and especially has an obvious synergistic effect on the asparagus stem blight in a ratio range of 20:1-1:20. In the present invention, a fungicide can be prepared as having a commonly-used agricultural dosage through a certain technical means, and the fungicide can provide an effective management tool for controlling of the asparagus stem blight.

This application claims priority to Chinese application number 201810902508.9, filed Aug. 9, 2018, with a title of FUNGICIDAL COMPOSITION AND FUNGICIDE FOR CONTROLLING ASPARAGUS STEM BLIGHT. The above-mentioned patent application is incorporated herein by reference in its entirety.

### TECHNICAL FIELD

The present invention relates to the technical field of controlling asparagus stem blight, and in particular, to a fungicidal composition and a fungicide for controlling asparagus stem blight.

### BACKGROUND

Asparagus officinalis (Asparagus officinalis Linn.), which is also called asparago, belongs to the family of Liliaceae in the genus of Asparagus. The asparagus officinalis has a high nutritional value, can moisten the lung, relieve cough, and eliminate phlegm, has the function of inhibiting tumor growth, and win the laudatory title of “the king of vegetables” in the international market. In recent years, with the cultivation area expansion of asparagus officinalis, the incidence of asparagus stem blight disease has increased year by year, which seriously affects the yield and quality of asparagus officinalis.

The long-term and large-scale use of chemical agents for controlling asparagus stem blight in the prior art led to the situation where the pathogenic fungi have developed strong drug resistance in many areas and thus the effects of farm chemicals have been greatly reduced. Therefore, it is particularly important to find an alternative agent for controlling the stem blight.

### SUMMARY

An objective of the present invention is to provide a fungicidal composition and a fungicide for controlling asparagus stem blight, and the composition has an obvious synergistic effect on asparagus stem blight.

In order to achieve the foregoing invention objective, the present invention provides the following technical solutions:

The present invention provides a fungicidal composition for controlling asparagus stem blight, which includes difenoconazole and propamidine; where the weight ratio of the difenoconazole to the propamidine is 20:1-1:20.

The present invention provides use of the fungicidal composition for controlling asparagus stem blight as described in the aforementioned solution in controlling the asparagus stem blight caused by Phomopsis asparagi (Sacc.).

The present invention provides a fungicide for controlling asparagus stem blight, including the composition for controlling asparagus stem blight as described in the aforementioned solution and auxiliary materials; and

the mass percentage content of the fungicidal composition in the fungicide is 3%-90%.

Preferably, the dosage form of the fungicide is an emulsifiable concentrate, an aqueous suspension, an oil suspension, a water-dispersible granule, or wettable powder.

Preferably, the emulsifiable concentrate includes the following raw materials in percentage by weight: 1%-30% of difenoconazole, 1%-10% of propamidine, 10%-17% of a dispersant, 10%-30% of a cosolvent, and the balance of xylene.

Preferably, the aqueous suspension includes the following raw materials in percentage by weight: 0.1%-40% of difenoconazole, 0.1%-40% of propamidine, 0.01%-17% of a dispersant, 0.05%-17% of a humectant, 0.01%-3% of a thickener, and the balance of deionized water.

Preferably, the oil suspension includes the following raw materials in percentage by weight: 0.1%-30% of difenoconazole, 0.05%-30% of propamidine, 0.01%-14% of a dispersant, 0.05%-13% of a humectant, 0.01%-3% of a thickener, and the balance of a liquid carrier; where the liquid carrier is one or more of soybean oil, corn oil, rapeseed oil, turpentine, methyl oleate, coconut oil, and palm oil.

Preferably, the water-dispersible granule includes the following raw materials in percentage by weight: 0.1%-70% of difenoconazole, 0.1%-20% of propamidine, 0.05%-10% of a dispersant, 0.1%-12% of a humectant, 0.2%-10% of a disintegrant, and the balance of a solid carrier; where the disintegrant is one or more of carboxymethyl starch sodium, low-substituted hydroxypropyl cellulose, croscarmellose sodium, crospovidone, chitosan, sodium alginate, sodium hydrogen carbonate, magnesium chloride, aluminum chloride, sodium chloride, urea, ammonium sulfate, and bentonite.

Preferably, the wettable powder includes the following raw materials in percentage by weight: 0.1%-70% of difenoconazole, 0.1%-20% of propamidine, 0.1%-14% of a dispersant, 0.1%-12% of a humectant, and the balance of a solid carrier.

Preferably, the solid carrier is one or more of light calcium carbonate, pottery clay, kaolin, diatomaceous earth, bentonite, white carbon, clay, attapulgite, talcum powder, and quartz sand.

The beneficial effects of the present invention: the present invention uses difenoconazole and propamidine as active ingredients, where a combined use of them has a synergistic effect on the pathogenic fungi of asparagus stem blight, and especially has an obvious synergistic effect on controlling the asparagus stem blight in a ratio range of 20:1-1:20. In the present invention, the fungicidal composition is further prepared into a fungicide of a certain dosage form, and the fungicide can provide an effective management tool for controlling of the asparagus stem blight.

### DETAILED DESCRIPTION

The present invention provides a fungicidal composition for controlling asparagus stem blight, which includes difenoconazole and propamidine; where the weight ratio of the difenoconazole to the propamidine is 20:1-1:20; preferably 15:1-1:10; more preferably 10:1-1:1, and most preferably 3:1.

The present invention provides use of the fungicidal composition for controlling asparagus stem blight as described in the aforementioned solution in controlling the asparagus stem blight caused by Phomopsis asparagi (Sacc.). The present invention provides a fungicide for controlling asparagus stem blight, including the composition for controlling asparagus stem blight as described in the aforementioned solution and auxiliary materials; where the mass percentage content of the fungicidal composition in the fungicide is 3-90%, preferably 10%-40%, and more preferably 30%; and the dosage form of the fungicide is an emulsifiable concentrate, an aqueous suspension, an oil suspension, a water-dispersible granule, or wettable powder.

In the present invention, the emulsifiable concentrate includes the following raw materials in percentage by weight: 1%-30% of difenoconazole, 1%-10% of propamidine, 10%-17% of a dispersant, 10%-30% of a cosolvent, and the balance of xylene; preferably, the emulsifiable concentrate includes the following raw materials in percentage by weight: 5%-25% of difenoconazole, 2%-8% of propamidine, 12%-15% of a dispersant, 15%-25% of a cosolvent, and the balance of xylene; more preferably, the emulsifiable concentrate includes the following raw materials in percentage by weight: 15% of difenoconazole, 5% of propamidine, 13% of a dispersant, 18% of a cosolvent, and the balance of xylene; the mass percentage content of the total amount of difenoconazole and propamidine in the emulsifiable concentrate is preferably 3%-40%, more preferably 5%-30%, and most preferably 20%; the dispersant is preferably one or more of alkylphenol ethoxylate formaldehyde condensate, naphthalenesulfonate formaldehyde condensate, p-methoxy fatty-acyl aminobenzene sulfonic acid, lignosulfonate, polycarboxylate, alkylphenol ethoxylate sulfate, calcium alkylbenzene sulfonate, lauryl betaine, fatty acid ester sulfate, alkylphenol ethoxylate and fatty alcohol-polyoxyethylene ether, and more preferably one or more of lignosulfonate, polycarboxylate, calcium alkylbenzene sulfonate, lauryl betaine and alkylphenol ethoxylate; and the cosolvent is one or more of methanol, ethanol, dimethylformamide and pyrrolidone, and more preferably ethanol.

In the present invention, a method for preparing the emulsifiable concentrate includes the following steps:

1) well mixing difenoconazole, propamidine, a cosolvent and xylene to obtain a component A; and

2) mixing the component A and a dispersant by stirring to obtain the emulsifiable concentrate.

In the present invention, difenoconazole, propamidine, the cosolvent, and xylene are mixed well to obtain the component A; and the present invention has no specific limitation on the dissolution time and dissolution temperature, as long as it is mixed well.

In the present invention, after the component A is obtained, the component A is mixed with the dispersant by stirring to obtain the emulsifiable concentrate; and the present invention has no specific limitation on the time, temperature and rotation speed of the by stirring, as long as it is mixed well.

In the present invention, the aqueous suspension includes the following raw materials in percentage by weight: 0.1%-40% of difenoconazole, 0.1%-40% of propamidine, 0.01%-17% of a dispersant, 0.05%-17% of a humectant, 0.01%-3% of a thickener, and the balance of deionized water; preferably, the aqueous suspension includes the following raw materials in percentage by weight: 1%-20% of difenoconazole, 1%-20% of propamidine, 1%-10% of a dispersant, 1%-10% of a humectant, 0.5%-2% of a thickener, and the balance of deionized water; and more preferably, the aqueous suspension includes the following raw materials in percentage by weight: 10% of difenoconazole, 3% of propamidine, 5% of a dispersant, 5% of a humectant, 1% of a thickener, and the balance of deionized water; the dispersant is selected from the dispersants described in the aforementioned emulsifiable concentrate, and thus will not be described any more; the humectant is preferably one or more of lauryl sodium sulfate, sodium dodecylbenzene sulfonate, sodium butyl naphthalene sulfonate, sodium alkyl sulfonate, sasangua cake powder, saponin powder and sapindus powder, and more preferably sodium dodecylbenzene sulfonate; the thickener is preferably one or more of polyvinyl acetate, xanthan gum, gelatin, arabic gum, aluminium-magnesium silicate, phenolic resin, hydroxymethyl cellulose and sodium alginate, and more preferably arabic gum; and the deionized water is preferably industrial deionized water. In the specific implementation of the present invention, the aqueous suspension further includes an antifreezing agent; the mass percentage content of the antifreezing agent is preferably 2%-5%, and more preferably 3%-4%; the antifreezing agent is preferably one or more of glycerin, propylene glycol, diethylene glycol and urea, and more preferably glycerin.

In the present invention, the method for preparing the aqueous suspension includes the following steps: mixing difenoconazole, propamidine, a dispersant, a humectant, a thickener, an antifreezing agent and deionized water by stirring, and then subsequently subjecting to high-speed shear dispersion and sanding treatments to obtain the aqueous suspension; where the rate of the mixing by stirring is preferably 100-5,000 revolution/min, more preferably 1,000-4,000 revolution/min, and most preferably 4,000 revolution/min; the time for the high-speed shear is preferably 15-60 min, and more preferably 30 min; the rate of the high-speed shear is preferably 100-10,000 revolution/min, and more preferably 4,000 to 6,000 revolution/min; and the time for the sanding treatment is preferably 1-2 h, and more preferably 1.5 h. In the present invention, it is liable to generate bubbles from the formulation during the process of shearing or sanding treatment, and thus it needs to conduct defoaming treatment with an antifoaming agent at any time; the antifoaming agent preferably accounts for 0.1% by weight of the aqueous suspension; and the antifoaming agent is preferably one or more of a silicone compound, epoxidized soybean oil, methanol, and silicone oil. The aqueous suspension prepared in the present invention is a highly-dispersed and stable suspension system.

In the present invention, the oil suspension includes the following raw materials in percentage by weight: 0.1%-30% of difenoconazole, 0.05%-30% of propamidine, 0.01%-14% of a dispersant, 0.05%-13% of a humectant, 0.01%-3% of a thickener, and the balance of a liquid carrier; preferably, the oil suspension includes the following raw materials in percentage by weight: 1%-20% of difenoconazole, 1%-20% of propamidine, 1%-10% of a dispersant, 1%-10% of a humectant, 0.5%-2% of a thickener, and the balance of a liquid carrier; and more preferably, the oil suspension includes the following raw materials in percentage by weight: 10% of difenoconazole, 3% of propamidine, 5% of a dispersant, 5% of a humectant, 1% of a thickener, and the balance of a liquid carrier; the dispersant is selected from the dispersants described in the aforementioned emulsifiable concentrate, and thus will not be described any more; the humectant is selected from the humectants described in the aforementioned aqueous suspension, and thus will not be described any more; the thickener is selected from the thickeners described in the aforementioned aqueous suspension, and thus will not be described any more; the liquid carrier is one or more of soybean oil, corn oil, rapeseed oil, turpentine, methyl oleate, coconut oil, and palm oil, and preferably turpentine and methyl oleate.

In the present invention, the method for preparing the oil suspension includes the following steps: mixing difenoconazole, propamidine, a dispersant, a humectant, a thickener and deionized water, and then subsequently subjecting to sanding and high-speed shear dispersion treatments to obtain the oil suspension; where the mixing time is preferably 1-3 h, and more preferably 2 h; the container for the mixing is preferably a reaction kettle mixer; the container for the high-speed shearing is preferably a high-shear emulsifier; and the apparatus for the sanding treatment is preferably a sand mill. The present invention has no particular limitation on the time of high-speed shearing, the rate of high-speed shearing, and the time of sanding treatment. The oil suspension prepared in the present invention is a highly-dispersed and stable suspension system.

In the present invention, the water-dispersible granule includes the following raw materials in percentage by weight: 0.1%-70% of difenoconazole, 0.1%-20% of propamidine, 0.05%-10% of a dispersant, 0.1%-12% of a humectant, 0.2%-10% of a disintegrant, and the balance of a solid carrier; preferably, the water-dispersible granule includes the following raw materials in percentage by weight: 1%-30% of difenoconazole, 1%-10% of propamidine, 1%-5% of a dispersant, 1%-6% of a humectant, 1%-5% of a disintegrant, and the balance of a solid carrier; and more preferably, the water-dispersible granule includes the following raw materials in percentage by weight: 15% of difenoconazole, 5% of propamidine, 2% of a dispersant, 3% of a humectant, 2% of a disintegrant, and the balance of a solid carrier; the dispersant is selected from the dispersants described in the aforementioned emulsifiable concentrate, and thus will not be described any more; the humectant is selected from the humectants described in the aforementioned aqueous suspension, and thus will not be described any more; the disintegrant is one or more of carboxymethyl starch sodium, low-substituted hydroxypropyl cellulose, croscarmellose sodium, crospovidone, chitosan, sodium alginate, sodium hydrogen carbonate, magnesium chloride, aluminum chloride, sodium chloride, urea, ammonium sulfate, and bentonite, and preferably bentonite; and the solid carrier is one or more of light calcium carbonate, pottery clay, kaolin, diatomaceous earth, bentonite, white carbon, clay, attapulgite, talcum powder, and quartz sand, and preferably white carbon and kaolin. In a specific implementation of the present invention, the water-dispersible granule further includes a binder; the mass percentage content of the binder is preferably 1%-8%, more preferably 2%-6%, and most preferably 3%-5%; the binder is preferably one or more of sucrose, glucose, polyvinyl alcohol, polyethylene glycol, sodium carboxymethyl cellulose, calcium carboxymethyl cellulose, carboxypropyl cellulose, dextrin, amylodextrin, polyvinylpyrrolidone, viscous kaolin, paraffin, and rosin.

In the present invention, a method for preparing the water-dispersible granule includes the following steps:

1) well mixing difenoconazole, propamidine, propamidine, a dispersant, a humectant, a disintegrant and a solid carrier, and then pulverizing the mixture to obtain a component B;

2) subsequently subjecting the component B to kneading and granulating to obtain a component C; and

3) subsequently subjecting the component C to drying and sieving to obtain the water-dispersible granule.

In the present invention, the difenoconazole, propamidine, propamidine, the dispersant, the humectant, the disintegrant and the solid carrier are well mixed, and then pulverized to obtain the component B; the pulverizing manner is preferably ultramicro airflow pulverization; and the particle size of the component B is preferably 1-10 μm, more preferably 2-8 μm, and most preferably 5 μm.

In the present invention, after obtained, the component B is sequentially kneaded and granulated to obtain the component C; and the particle size of the component C is preferably 0.5-4 mm, more preferably 1-3 mm, and most preferably 2 mm.

In the present invention, after obtained, the component C is sequentially dried and sieved to obtain the water-dispersible granule; the drying temperature is preferably 50-100° C., more preferably 60-90° C., and most preferably 70-80° C.; the drying manner is preferably forced air drying; in the sieving process the mesh number of the sieve is preferably 500-700 mesh, and more preferably 600 mesh; and the water content of the water-dispersible granule is preferably 3%, and more preferably 2%.

In the present invention, the wettable powder includes the following raw materials in percentage by weight: 0.1%-70% of difenoconazole, 0.1%-20% of propamidine, 0.1%-14% of a dispersant, 0.1%-12% of a humectant, and the balance of a solid carrier; preferably, the wettable powder includes the following raw materials in percentage by weight: 1%-30% of difenoconazole, 1%-10% of propamidine, 1%-7% of a dispersant, 1%-6% of a humectant, and the balance of a solid carrier; and more preferably the wettable powder includes the following raw materials in percentage by weight: 15% of difenoconazole, 5% of propamidine, 4% of a dispersant, 3% of a humectant, and the balance of a solid carrier; the dispersant is selected from the dispersants described in the aforementioned emulsifiable concentrate, and thus will not be described any more; the humectant is selected from the humectants described in the aforementioned aqueous suspension, and thus will not be described any more; and the solid carrier is selected from the solid carriers described in the aforementioned water-dispersible granule, and thus will not be described any more.

In the present invention, the method for preparing the wettable powder includes the following steps: well mixing difenoconazole, propamidine, a dispersant, a humectant and a solid carrier, and then sequentially subjecting to a first pulverization, a second pulverization, and sieving to obtain the wettable powder; the manner of the first pulverization is preferably mechanical pulverization; the manner of the second pulverization is preferably airflow pulverization; and the particle size after the second pulverization is preferably 1-10 μm, and more preferably 2-5 μm; and the mesh number of the sieve during the sieving process is preferably 500-700 mesh, and more preferably 600 mesh.

The fungicidal composition and the fungicide for controlling asparagus stem blight as provided by the present invention are described in detail below in connection with Embodiments, but these Embodiments should not be understood as limiting the claimed scope of the present invention.

### Embodiment 1

### Determination of Laboratory Toxicity of Difenoconazole-propamidine to Phomopsis asparagi (Sacc.)

According to Sun Yunpei method, the synergistic effect of the mixed drug was evaluated based on a cotoxicity coefficient (CTC). That was, CTC≤80 was the antagonistic effect, 80<CTC<120 was the antagonistic effect, and CTC≥120 was the synergistic effect. actually-determined toxicity index (ATI)=(EC50 of standard agent/EC50 of agent to be tested)×100; theoretical toxicity index TTI=toxicity index of drug A×percentage content of drug A in mixture+toxicity index of drug B×percentage content of drug B in mixture; co-toxicity coefficient (CTC)=[actually-determined toxicity index (ATI) of mixture/theoretical toxicity index (TTI) of mixture]×100

The subjects to be tested were pathogenic fungi of asparagus stem blight collected from the field. The determination method was conducted with reference to the mycelium growth rate method in “Technical regulation on agricultural construction project acceptance NY/T 1156.6-2006 of the People's Republic of China”.

TABLE 1
determination results of laboratory toxicity of
difenoconazole•propamidine to Phomopsis asparagi (Sacc.)

| | Formulation | | | | |
|---|---|---|---|---|---|
| Agents to be Tested | Ratio | EC50 (μg/ml) | ATI | TTI | CTC |
| difenoconazole | — | 0.088 | 100.00 | | |
| propamidine | — | 0.053 | 166.04 | | |
| difenoconazole:propamidine | 20:1 | 0.054 | 162.96 | 103.14 | 157.99 |
| difenoconazole:propamidine | 15:1 | 0.048 | 183.33 | 104.13 | 176.07 |
| difenoconazole:propamidine | 10:1 | 0.045 | 195.56 | 106.00 | 184.48 |
| difenoconazole:propamidine | 5:1 | 0.042 | 209.52 | 111.01 | 188.75 |
| difenoconazole:propamidine | 3:1 | 0.040 | 220.00 | 116.51 | 188.83 |
| difenoconazole:propamidine | 1:1 | 0.038 | 231.58 | 133.0189 | 174.09 |
| difenoconazole:propamidine | 1:3 | 0.035 | 251.43 | 149.5283 | 168.15 |
| difenoconazole:propamidine | 1:5 | 0.031 | 283.87 | 157.783 | 179.91 |
| difenoconazole:propamidine | 1:10 | 0.030 | 293.33 | 160.0343 | 183.29 |
| difenoconazole:propamidine | 1:15 | 0.034 | 258.82 | 161.9104 | 159.86 |
| difenoconazole:propamidine | 1:20 | 0.036 | 244.44 | 162.8931 | 150.06 |

It could be seen from Table 1 that, when difenoconazol was mixed with propamidine in a ratio range between 20:1 to 1:20, the mixture had an obvious synergistic effect on the Phomopsis asparagi (Sacc.), with each co-toxicity coefficient being greater than 150.

### Embodiment 2

### Emulsifiable Concentrate for Controlling Asparagus Stem Blight

| | |
|---|---|
| difenoconazole | 150 g |
| propamidine | 50 g |
| ethanol | 150 g |
| calcium dodecyl benzene sulfonate | 40 g |
| alkylphenol ethoxylate | 60 g |
| xylene | 550 g |

Difenoconazole and propamidine were dissolved in ethanol and xylene, then mixed with other agents calcium dodecyl benzene sulfonate and alkylphenol ethoxylate, and stirred to form a highly-dispersed and stable emulsifiable concentrate system.

The aforementioned resultant emulsifiable concentrate was diluted in 800 folds and sprayed, and the control effects were 92.5% and 85.6% respectively at day 7 and day 14 after administration; 200 g/L emulsifiable concentrate of difenoconazole was diluted in 800 folds and sprayed, and 10% aqueous solution of propamidine was diluted in 400 folds and sprayed, and the control effects were 83.2% and 71.8% versus 81.8% and 72.9% respectively at day 7 and day 14 after administration. It could be seen that the synergistic effect was obvious after difenoconazole was formulated together with propamidine, and the control effect on the asparagus stem blight was obviously better than that of either of them. The dosage of the active ingredients in the formulated agent was significantly reduced as compared with that when either of them was used alone, and the total active ingredient was also relatively reduced, thereby reducing environmental load and reducing the use cost.

### Embodiment 3

### Aqueous Suspension for Controlling Asparagus Stem Blight

| | |
|---|---|
| difenoconazole | 300 g |
| propamidine | 100 g |
| sodium lignosulfonate | 42 g |
| calcium dodecyl benzene sulfonate | 41 g |
| lauryl betaine | 50 g |
| fatty alcohol-polyoxyethylene ether | 60 g |
| glycerin | 51 g |
| arabic gum | 1.2 g |
| deionized water | 354.8 g |

The raw material was mixed by stirring at 1,000 revolution/min, then ground in a sand mill for 1.5 h, subjected to high-shear mixing at 5,000 revolution/minute, and then formulated to obtain a stable aqueous suspension.

The aforementioned resultant aqueous suspension was diluted in 1,000 folds and sprayed, and the control effects were 94.3% and 85.7% respectively at day 7 and day 14 after administration; and 20% suspension of difenoconazole was diluted in 500 folds and sprayed, and 10% aqueous solution of propamidine was diluted in 250 folds and sprayed, and the control effects were 82.6% and 70.2% versus 82.5% and 71.4% respectively at day 7 and day 14 after administration. It could be seen that the synergistic effect was obvious after difenoconazole was formulated together with propamidine, and the control effect on the asparagus stem blight was obviously better than that of either of them. The dosage of the active ingredients in the formulated agent was significantly reduced as compared with that when either of them was used alone, and the total active ingredient was also relatively reduced, thereby reducing environmental load and reducing the use cost, and providing a grower with a more effective management tool for the asparagus stem blight.

### Embodiment 4

### Oil Suspension for Controlling Asparagus Stem Blight

| | |
|---|---|
| difenoconazole | 150 g |
| propamidine | 150 g |
| phenylethyl phenol polyoxyethylene ether | 50 g |
| sodium lignosulfonate | 50 g |
| methyl oleate | 200 g |
| organic bentonite | 80 g |
| calcium dodecanesulfonate | 80 g |
| turpentine | 240 g |

The aforementioned materials (other than organic bentonite) were added together into a reaction kettle mixer, stirred for 2 h, ground by pouring the material into a multi-stage sand mill through an opened feed valve at the bottom of the kettle, and the material was discharged after 98% of the fineness of the ground material passed through 1-5 μm, the discharged material was placed into a high-shear emulsifying kettle together with the previously-dissolved organic bentonite, so as to prepare an oil suspension with good fluidity after emulsification.

The aforementioned resultant oil suspension was diluted in 1,000 folds and sprayed, and the control effects were 93.3% and 84.7% respectively at day 7 and day 14 after administration; and 30% suspension of difenoconazole was diluted in 1,000 folds and sprayed, and 15% oil suspension of propamidine was diluted in 500 folds and sprayed, and the control effects were 84.6% and 73.2% versus 80.5% and 70.1% respectively at day 7 and day 14 after administration. It could be seen that the synergistic effect was obvious after difenoconazole was formulated together with propamidine, and the control effect on the asparagus stem blight was obviously better than that of either of them. The dosage of the active ingredients in the formulated agent was significantly reduced as compared with that when either of them was used alone, and the total active ingredient was also relatively reduced, thereby reducing environmental load and reducing the use cost.

### Embodiment 5

### Water-Dispersible Granule for Controlling Asparagus Stem Blight

| | |
|---|---|
| difenoconazole | 500 g |
| propamidine | 100 g |
| calcium lignosulphonate | 52 g |
| polycarboxylate | 61 g |
| glucose | 51 g |
| naphthalene sulfonate | 45 g |
| kaolin | 191 g |

The aforementioned materials were added together into a conical mixer and well mixed, and then pulverized by an airflow pulverizer to have a particle size of 1-10 μm, and the pulverized material was mixed again by the conical mixer. When 98% of the fineness of the mixed material passed through a standard sieve of 600 mesh, the mixed material was kneaded in a kneader to form a malleable material, and finally the material was placed into an extrusion granulator for extruding granulation, and the granulated material was dried and sieved to obtain a water-dispersible granule.

The aforementioned resultant water-dispersible granule was diluted in 1,000 folds and sprayed, and the control effects were 94.5% and 83.8% respectively at day 7 and day 14 after administration; and 30% water-dispersible granule of difenoconazole was diluted in 500 folds and sprayed, and 30% water-dispersible granule of propamidine was diluted in 500 folds and sprayed, and the control effects were 83.1% and 72.0% versus 82.8% and 69.9% respectively at day 7 and day 14 after administration. The synergistic effect was obvious after difenoconazole was formulated together with propamidine, and the control effect was obviously better than that of either of them. The dosage of the active ingredients in the formulated agent was significantly reduced as compared with that when either of them was used alone, and the total active ingredient was also relatively reduced, thereby reducing environmental load and reducing the use cost, and providing a grower with a more effective management tool for the asparagus stem blight.

### Embodiment 6

### Wettable Powder for Controlling Asparagus Stem Blight

| | |
|---|---|
| difenoconazole | 400 g |
| propamidine | 100 g |
| lauryl sodium sulfate | 54 g |
| fatty alcohol-polyvinylether | 42 g |
| calcium lignosulphonate | 51 g |
| white carbon | 51 g |
| kaolin | 302 g |

The aforementioned materials were added together into a conical mixer and well mixed, and then subjected to mechanical pulverization and pulverization by an airflow pulverizer. The pulverized material was mixed again by the conical mixer, and when 98% of the fineness of the mixed material passed through a standard sieve of 600 mesh, the difenoconazole.propamidine wettable powder having the corresponding percentage by weight was obtained.

The aforementioned wettable powder was diluted by water in 1,000 folds and sprayed, and the control effects were 91.7% and 83.3% respectively at day 7 and day 14 after administration; and 50% wettable powder of difenoconazole was diluted in 1,000 folds and sprayed, and 10% aqueous solution of propamidine was diluted in 250 folds and sprayed, and the control effects were 83.2% and 73.2% versus 81.5% and 70.4% respectively at day 7 and day 14 after administration. It could be seen that the synergistic effect was obvious after difenoconazole was formulated together with propamidine, and the control effect was obviously better than that of either of them. The dosage of the active ingredients in the formulated agent was significantly reduced as compared with that when either of them was used alone, and the total active ingredient was also relatively reduced, thereby reducing environmental load and reducing the use cost, and providing a grower with a more effective management tool for the asparagus stem blight.

It could be seen from the aforementioned embodiments that, the present invention provides a fungicidal composition and a fungicide for controlling asparagus stem blight. The synergistic effect was obvious after difenoconazole was formulated together with propamidine, and the control effect was obviously better than that of either of them. The dosage of the active ingredients in the formulated agent was significantly reduced as compared with that when either of them was used alone, and the total active ingredient was also relatively reduced, thereby reducing environmental load and reducing the use cost, and providing a grower with a more effective management tool for the asparagus stem blight.

The foregoing descriptions are only preferred implementation manners of the present invention. It should be noted that for a person of ordinary skill in the art, several improvements and modifications may further be made without departing from the principle of the present invention. These improvements and modifications should also be deemed as falling within the protection scope of the present invention.

What is claimed is:

1. A fungicidal composition for controlling asparagus stem blight, comprising difenoconazole and propamidine; wherein the weight ratio of the difenoconazole to the propamidine is 20:1-1:20.

2. Use of the fungicidal composition for controlling asparagus stem blight according to claim 1 in controlling the asparagus stem blight caused by Phomopsis asparagi (Sacc.).

3. A fungicide for controlling asparagus stem blight, comprising the fungicidal composition for controlling asparagus stem blight according to claim 1 and auxiliary materials; and
the mass percentage content of the fungicidal composition in the fungicide is 3%-90%.

4. The fungicide for controlling asparagus stem blight according to claim 3, wherein the dosage form of the fungicide is an emulsifiable concentrate, an aqueous suspension, an oil suspension, a water-dispersible granule, or wettable powder.

5. The fungicide for controlling asparagus stem blight according to claim 4, wherein the emulsifiable concentrate comprises the following raw materials in percentage by weight: 1%-30% of difenoconazole, 1%-10% of propamidine, 10%-17% of a mixture of alkylphenol ethoxylate and calcium dodecyl benzene sulfonate, 10%-30% of ethanol, and the balance of xylene.

6. The fungicide for controlling asparagus stem blight according to claim 4, wherein the aqueous suspension comprises the following raw materials in percentage by weight: 0.1%-40% of difenoconazole, 0.1%-40% of propamidine, 0.01%-17% of a mixture of alkylphenol ethoxylate and calcium dodecyl benzene sulfonate, 0.05%-17% of sodium dodecylbenzene sulfonate, 0.01%-3% of arabic gum, and the balance of deionized water.

7. The fungicide for controlling asparagus stem blight according to claim 4, wherein the oil suspension comprises the following raw materials in percentage by weight: 0.1%-30% of difenoconazole, 0.05%-30% of propamidine, 0.01%-14% of a mixture of alkylphenol ethoxylate and calcium dodecyl benzene sulfonate, ate 0.05%-13% of sodium dodecylbenzene sulfonate, 0.01%-3% of arabic gum, and the balance of mixture of turpentine and methyl oleate.

8. The fungicide for controlling asparagus stem blight according to claim 4, wherein the water-dispersible granule comprises the following raw materials in percentage by weight: 0.1%-70% of difenoconazole, 0.1%-20% of propamidine, 0.05%-10% of a mixture of alkylphenol ethoxylate and calcium dodecyl benzene sulfonate, 0.1%-12% of sodium dodecylbenzene sulfonate, 0.2%-10% of carboxymethyl starch sodium, and the balance of kaolin and white carbon.

9. The fungicide for controlling asparagus stem blight according to claim 4, wherein the wettable powder comprises the following raw materials in percentage by weight: 0.1%-70% of difenoconazole, 0.1%-20% of propamidine, 0.1%-14% of a mixture of alkylphenol ethoxylate and calcium dodecyl benzene sulfonate, 0.1%-12% of a sodium dodecylbenzene sulfonate, and the balance of kaolin and white carbon.

10. (canceled)

11. (canceled)
